(19) United States
(12) Patent Application Publication
(10) Pub. No.: US 2013/0198788 A1
(43) Pub. Date: Aug. 1, 2013

(54) SOCIAL VIDEO NETWORK

(71) Applicant: AUTOMATED MEDIA PROCESSING SOLUTIONS, INC, DBA, Sausalito, CA (US)

(72) Inventors: Sean Barger, Mill Valley, CA (US); Brian Rice, Darien, IL (US); David Pochron, Cambridge, WI (US); Matt Butler, Beaverton, OR (US); James Hays, Windsor, CO (US); Daniel Kenyon, Novato, CA (US)

(73) Assignee: AUTOMATED MEDIA PROCESSING SOLUTIONS, INC, DBA EQUILIBRIUM, AMPS, INC., Sausalito, CA (US)

(21) Appl. No.: 13/745,622

(22) Filed: Jan. 18, 2013

Related U.S. Application Data
(63) Continuation-in-part of application No. 12/489,308, filed on Jun. 22, 2009.
Application No. 12/489,308 is a continuation-in-part of application No. 11/269,916, filed on Nov. 7, 2005, now abandoned.
Application No. 11/269,916 is a continuation-in-part of application No. 09/929,904, filed on Aug. 14, 2001, now Pat. No. 6,964,009.
Application No. 09/929,904 is a continuation-in-part of application No. 09/425,326, filed on Oct. 21, 1999, now Pat. No. 6,792,575.
(60) Provisional application No. 61/589,129, filed on Jan. 20, 2012.
(60) Provisional application No. 61/074,519, filed on Jun. 20, 2008.

(51) Int. Cl. H04N 21/266

(52) U.S. Cl. CPC H04N 21/266
USPC 725/93; 725/32

(57) ABSTRACT

An architecture is disclosed that enables users to upload videos directly from a camera or from saved videos from most video devices into video channels and automatically publish and notify to all who subscribe to channels or follow accounts. Embodiments allow users to share videos to social services, such as Facebook and Twitter, automatically display in embedded channels on any Website, directly to a Facebook or other developed applications using an Application Program Interface (API). Users can search, subscribe, view, and manage their video channels and videos, and modify their associated metadata content from anywhere.

### CROSS REFERENCE TO RELATED APPLICATIONS

This application claims priority to U.S. provisional patent application Ser. No. 61/589,129, filed Jan. 20, 2012, and is a continuation-in-part of U.S. patent application Ser. No. 12/489,308, filed Jun. 22, 2009, which application claims priority to U.S. patent application Ser. No. 61/074,519 filed 20 Jun. 2008, and is a continuation-in-part of U.S. patent application Ser. No. 11/269,916, filed Nov. 7, 2005, which is a continuation-in-part of U.S. patent application Ser. No. 09/929,904, filed Aug. 14, 2001, now U.S. Pat. No. 6,964,009 granted on Nov. 8, 2005, which is a continuation-in-part of U.S. patent application Ser. No. 09/425,326, filed Oct. 21, 1999, now U.S. Pat. No. 6,792,575, granted on Sep. 14, 2004, each of which is incorporated herein in its entirety by this reference thereto.

### BACKGROUND OF THE INVENTION

1. Technical Field

The invention relates to video assets and other content. More particularly, the invention relates to social video network for uploading, ingesting, distributing, delivery, monetizing, and maintaining video assets of any type and size.

2. Description of the Background Art

The global digital video market is expanding exponentially, yet substantial challenges remain for both content owners and consumers. The creation, processing, delivery, sharing, and viewing of online streaming video is not yet a seamless experience for the delivery to the large number of platforms for mobile and Internet TV. Today's fragmented market of consumer electronic devices, coupled with a lack of sophisticated, but easy to use management tools means that most media companies and consumers have to resort to very tedious and expensive, manually intensive processes to upload, ingest, distribute, deliver, monetize and maintain their video assets.

It would be advantageous to provide an alternative to current hosted video capabilities and installable product suites, which are expensive to scale, do not provide instant end-to-end video delivery, and are highly frustrating to all involved.

### SUMMARY OF THE INVENTION

Embodiments of the invention solve the above-mentioned problems by providing a simple user experience that allows the user or other content owners to upload, watch, and share high quality (HD) video while eliminating any issues regarding differences in format and operating systems. A centralized approach for publishing and subscribing to video channels is disclosed that eliminates the high cost of mobilizing video content while enabling seamless watching experiences across devices. Thus, a user can create and publish private or public video channels that are automatically pushed to all who subscribe to such channels.

Embodiments of the invention provide high quality viewing of both public and private video content across smartphones, tablets, computers, and televisions from most video sources, file types, or cameras.

One embodiment of the invention comprises a hosted, cloud-based service that automatically transforms video on-the-fly, virtually eliminating the labor intensive preprocessing of video content and the programming exercise normally associated with supporting multiple devices. Thus, virtually any video file of any size from any application, Web page, or phone can be uploaded. No pre-processing is required. Embodiments of the invention automatically direct users to the right asset for their bandwidth and device, while also providing the ability to upgrade their quality level to the next available, should enhanced resolution be required.

An embodiment automatically logs videos as simple animations that show the content the user has sent, automatically updates all subscribers of a channel instantly when the video is ready, and automatically synchronizes what a user has watched.

Embodiments of the invention automatically publish videos to all desired locations. A service built around the invention enables users to create an account, upload videos of any length directly from a user device, and create private video channels which never show up in search or public video channels but that are available for anyone to subscribe to and follow. Every subscriber receives a video the instant a user uploads it, without the user sending e-mails or the subscriber being required to visit a Web site. Favorites enable automatic push of channel videos to allow a user watch them without an Internet connection.

A further embodiment of the invention provides a digital video recorder-like feature controlled by pocket-sized and tablet mobile devices for every video source. As such a user can watch videos wherever they are, whenever they want. Alerts show the user what is new and what is popular. All of the user's videos are in one place on any device, with complete control of all channels. For example, videos can be played directly to the user's screens with, for example Apple Airplay, or via converter cables.

### BRIEF DESCRIPTION OF THE DRAWINGS

FIG. 1 is a block schematic diagram showing an architecture of a social video network according to the invention;

FIG. 2 is a schematic representation of a social video network according to the invention;

FIG. 3 is a schematic representation of diverse audio/video file formats according to the invention;

FIGS. 4A-4E are screen shots of an application running on a handheld device that implements a social video network according to the invention;

FIG. 5A illustrates a schematic representation of an exemplary process defined by a request for content according to the invention;

FIG. 5B illustrates a representation of an example of a new composite media definition according to the invention;

FIG. 5C illustrates an example of a composite media definition after advertisements have been selected for the ad slots wherein the advertisements comprise diverse audio/video file formats according to the invention;

FIG. 5D illustrates an alternative representation of an alternative method for delivering digital media according to the invention;

FIG. 6A illustrates a schematic representation of a on-the-fly video export process used in digital funneling according to the invention;

FIG. 6B illustrates an exemplary digital audio/video funneling process according to the invention;

FIG. 6C illustrates a schematic representation of a on-the-fly audio synchronization process used together with the video processing for digital funneling according to the invention;

FIG. 6D illustrates one example of assembling a user-defined composite media file from a plurality of input files according to the invention;

FIG. 6E illustrates another example of assembling a user-defined composite media file from a plurality of input files according to the invention;

FIG. 7 is a flow diagram showing operation of an uploader according to the invention; and

FIG. 8 is a block schematic diagram that depicts a machine in the exemplary form of a computer system within which a set of instructions for causing the machine to perform any of the herein disclosed methodologies may be executed.

### DETAILED DESCRIPTION OF THE INVENTION

Embodiments of the invention solve the above-mentioned problems by providing a simple user experience that allows the user or other content owners to upload, watch, and share high quality (HD) video while eliminating any issues regarding differences in format and operating systems.

An embodiment of the invention provides a video service that eliminates pre-preparation of videos, automatically manages all content for high quality display on all devices, handles long and short form videos directly from cameras, and auto-synchronizes the environment for a view-anywhere experience. The invention provides seamless video delivery for high quality viewing on public and private channels across mobile phones, tablets, computers, and Internet TVs from almost any video source, file type, or camera. The invention also provides an extremely simple, highly intuitive, consumer interface that allows users to watch video where and when they want to.

Social networking aspects of the invention described herein include the ability of a user to create and publish private or public video channels that are automatically pushed to all who subscribe. An embodiment automatically logs the user's videos as simple animations showing the content the user has sent and automatically updates all subscribers of the user's channel instantly when the video is ready. Embodiments automatically synchronize what a user has watched, such that virtually any video file of any size from any application, Web page or phone can be uploaded. As discussed in greater detail below, no pre-processing required because an inventive automatic, on-the-fly transcoding scheme is employed.

The social video network thus provides a personal video network that allows a user to select among such functions as crowd source, location enabled, and invitation only communication. Videos may be sent from the field to the viewer, users may follow news communities, such as amateur sports networks, and the network permits viewer enabled contributions. Thus, the invention can be used to provide private video classrooms and interactive-personalized tutorials, which are privacy protected as desired or designated because of the use of private consumer channels and personal networks.

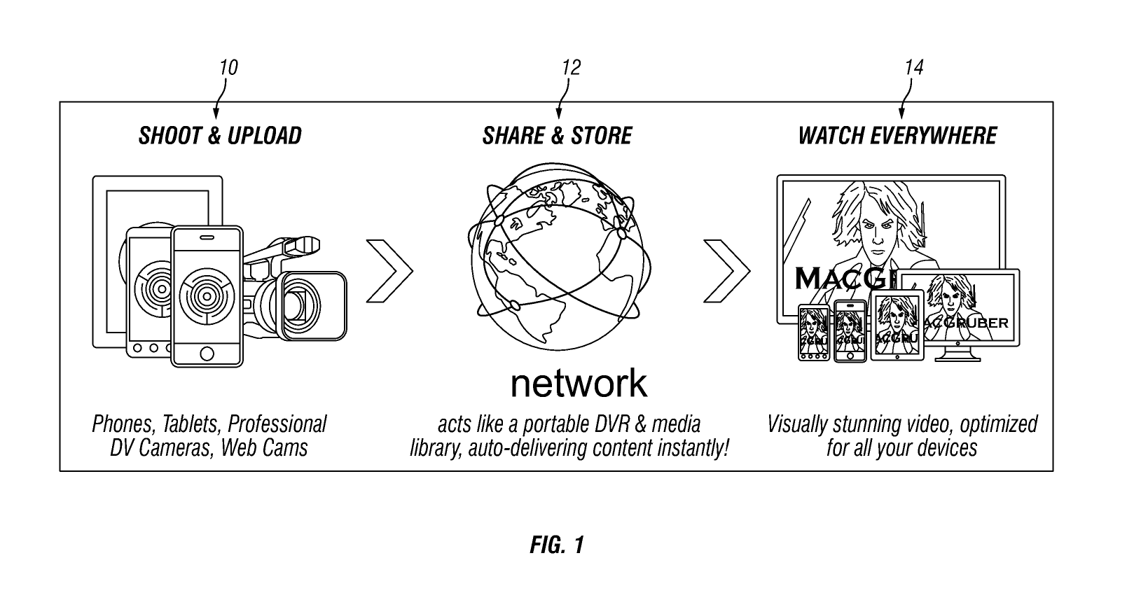

FIG. 1 is a block schematic diagram showing an architecture of a social video network according to the invention. A centralized approach for publishing and subscribing to video channels is disclosed that eliminates the high cost of mobilizing video content while enabling seamless watching experiences across devices. In an embodiment, a user shoots and uploads video 10, shares and stores the videos over a social network 12, and, via one or more channels, watches the videos at any locations and on any device as desired 14. In this way, a user can create and publish private or public video channels that are automatically pushed to all who subscribe to such channels. To accomplish this, in an embodiment a simple record button is pressed, or a follow button is provided at any location where a social subscribe button exists, including the Website, Facebook app, EQ Network Apps (EQN) (see http://eqnetwork.com/), on virtually any device or tablet, or via an EQN button on any Website where the EQN button is placed. In this way, the channel, or an entire set of channels, can be followed and show up instantly wherever the user is logged into an EQ Network connected account.

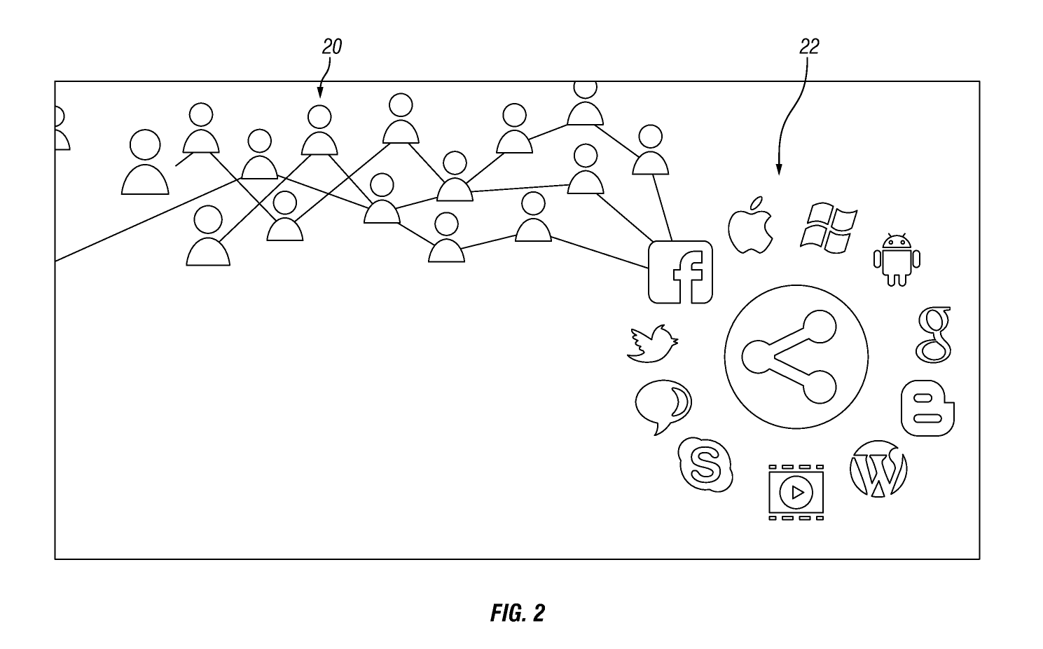

FIG. 2 is a schematic representation of a social video network according to the invention. An embodiment automatically logs videos as simple animations and thumbnails that show the content the user has sent and automatically updates all subscribers 20 of a channel 22 instantly when the video is ready and automatically synchronizes what a user has watched. The synchronization comes from both a tracking method comprised of variables related to the environment of the user, the length of time a user has viewed a video, which videos they have viewed prior, the unviewed videos and which videos may have been changed, removed, or added to any subscription list. This data is automatically delivered to any validated user session and can be delivered into, for example, the EQ Network ecosystem or any third party using the EQ Network API's.

Embodiments of the invention automatically publish videos to all desired locations. A service built around the invention enables user to create an account, upload a videos of any length directly from a user device, and create private video channels which never show up in search or public video channels but that are available for anyone to subscribe to and follow. Every subscriber receives a video the instant a user uploads it, without the user sending e-mails or the subscriber being required to visit a Web site. Favorites enable automatic push of channel videos to allow a user watch them without an Internet connection. Such publication is accomplished in an embodiment via a proprietary centralized tracking and delivery system, in which the client requests an update from the EQ Network cloud service whenever initiating a session. The EQ Network determines the payload of files needed for synchronization by analyzing the content files remaining-to-view on the client, sending the completed list and queries the server for new available videos, orders the removal of old items from the client cache, synchronizes the entire list of new files for off-line viewing, and then delivers the files to the client by automatically downloading the series of files to the client. The creation of private channels is secured by requiring authentication before access to a private account invitation is made possible. When a user's private video channel is requested, the user must have logged in with a validated e-mail address matching an address of those who can access the private channel. Removal of the user eliminates access to the private channel and all the contained videos. If a user has access to a private channel, an optional layer of security is presented by requiring a password on a per-video or per-channel basis. Even though someone might have access to the private channel, they must, in addition, type in the password to gain access to videos.

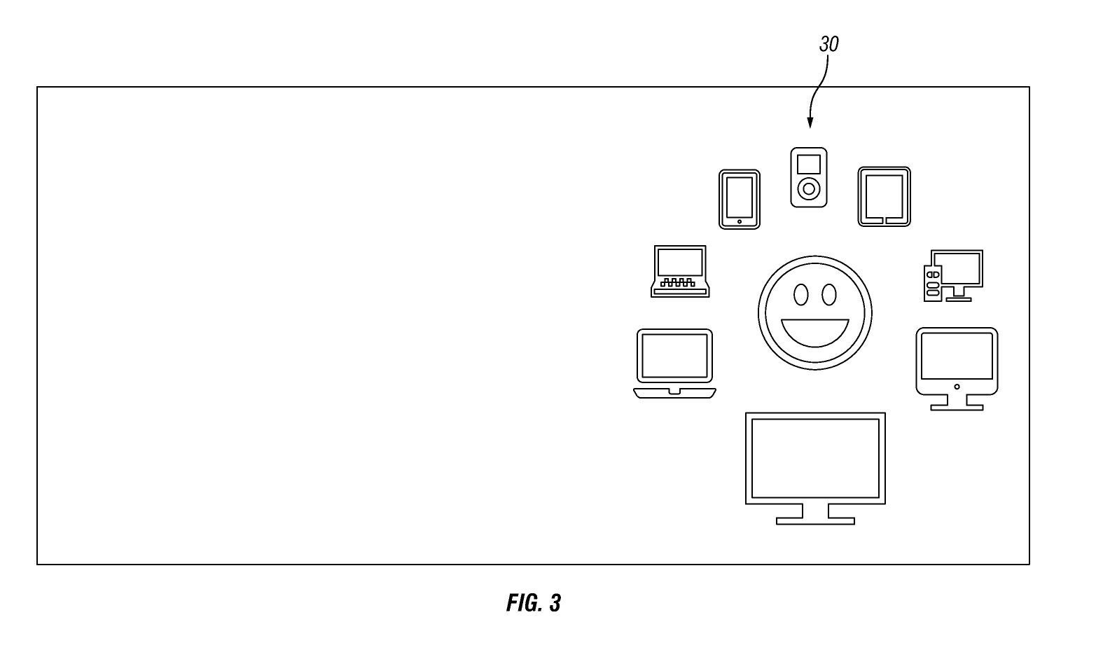

FIG. 3 is a schematic representation of diverse audio/video file formats according to the invention. Embodiments of the invention provide high quality viewing of both public and private video content across most devices 30, including for example smartphones, tablets, computers, and televisions from most video sources, file types, or cameras.

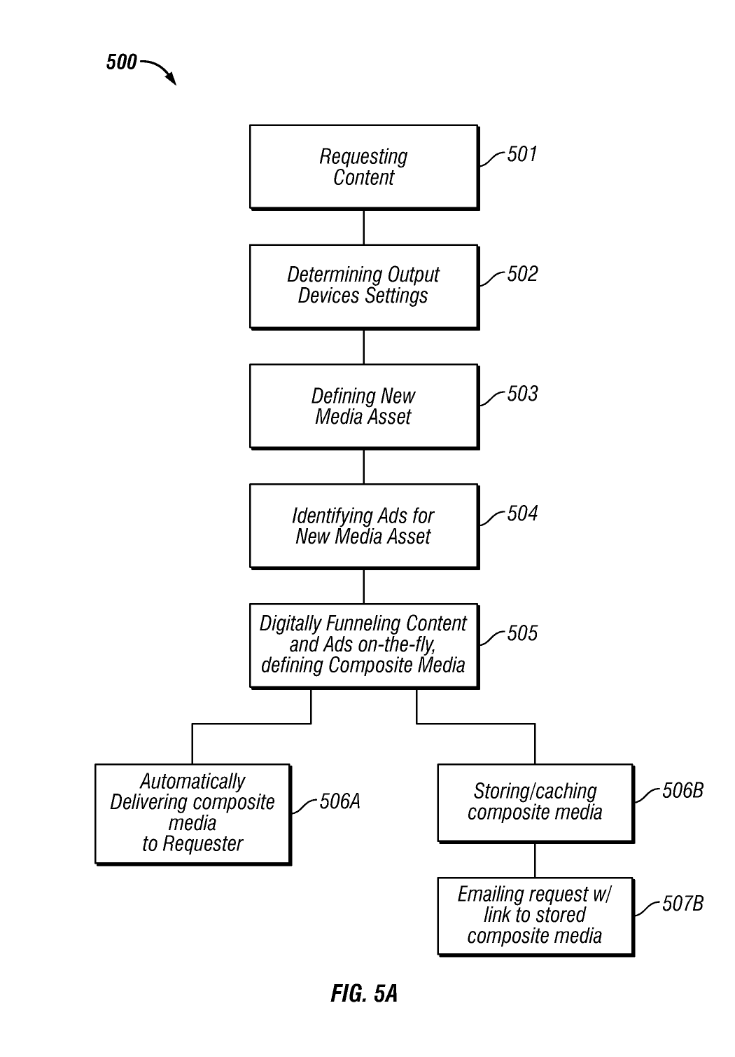

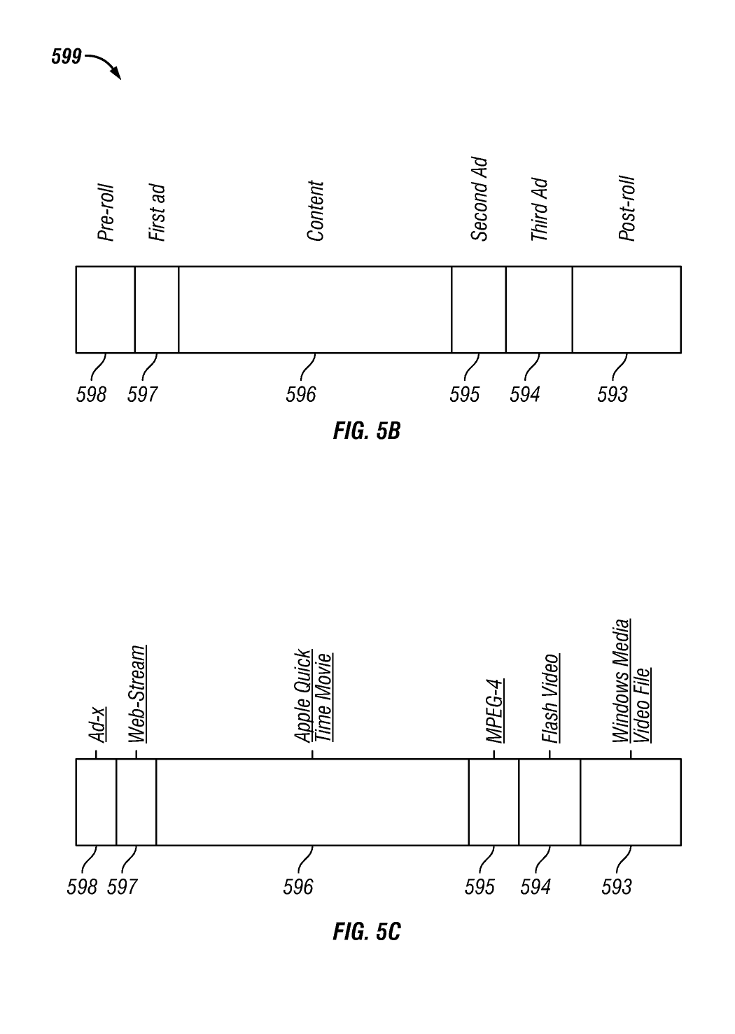

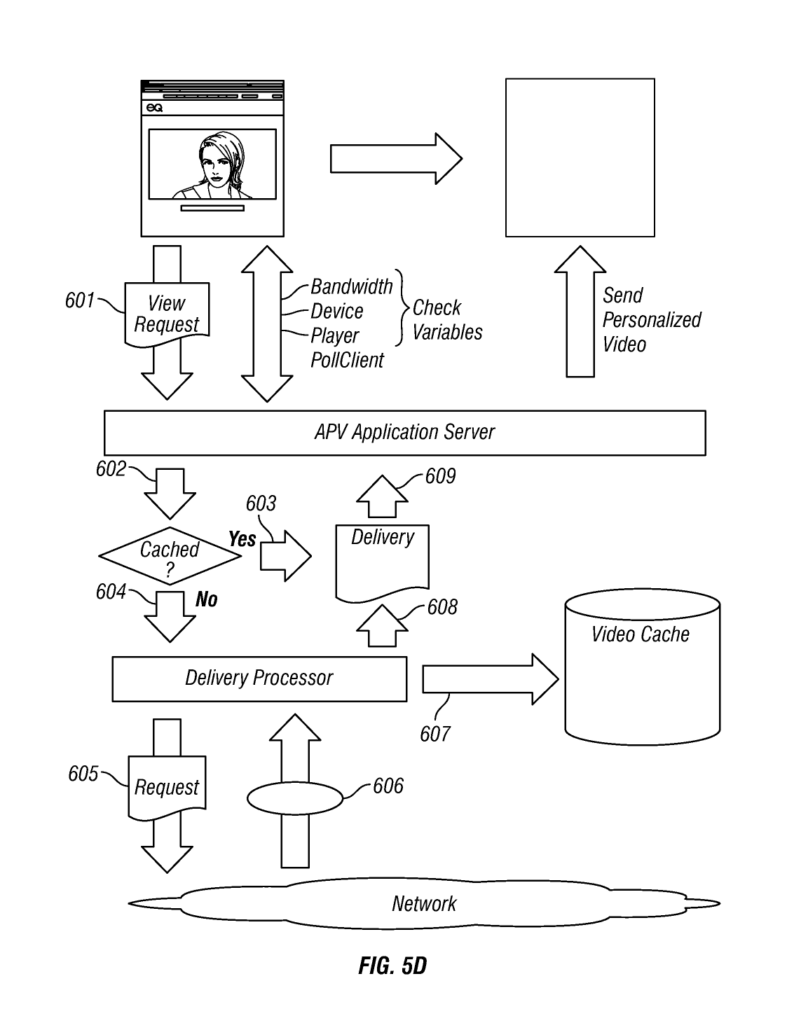

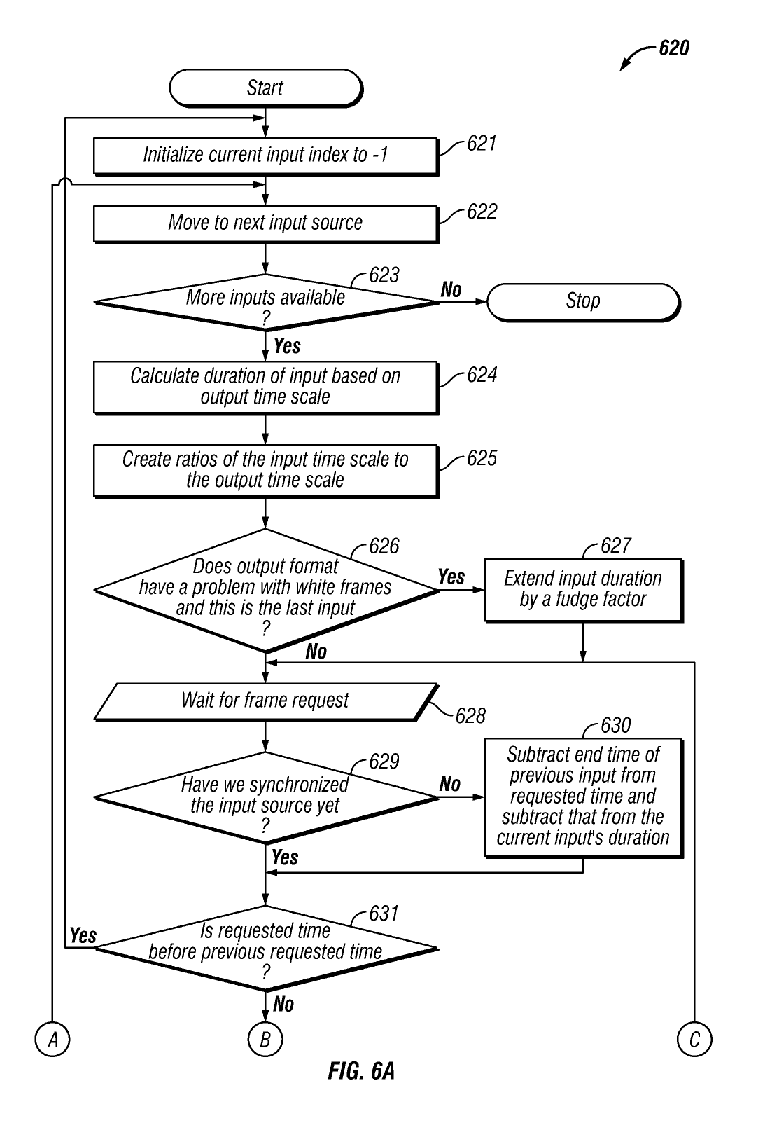

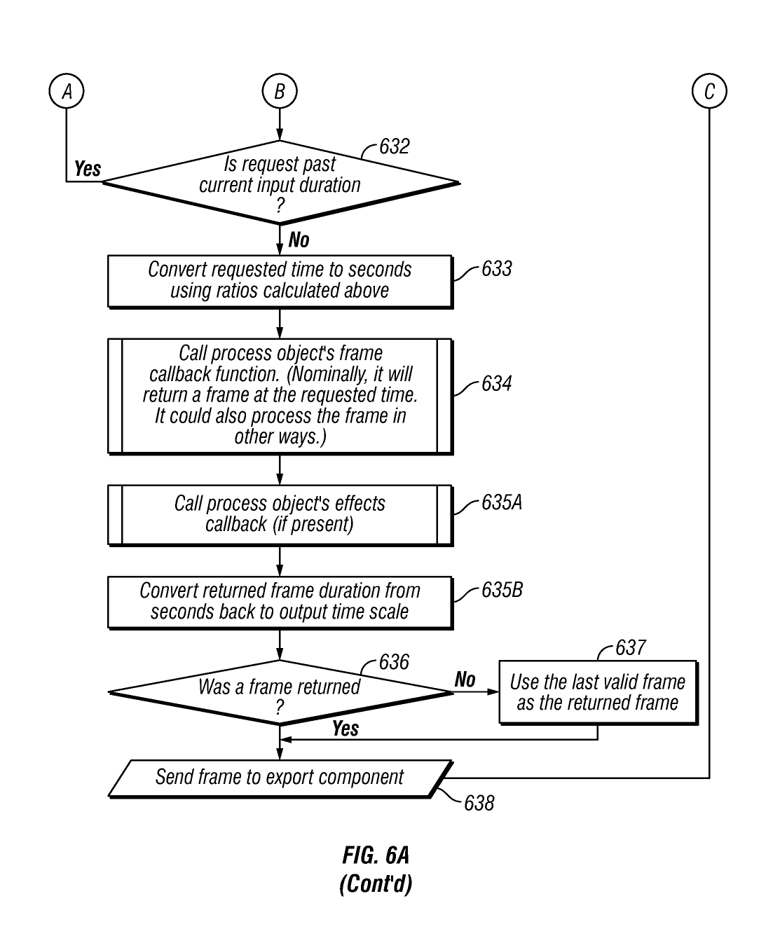

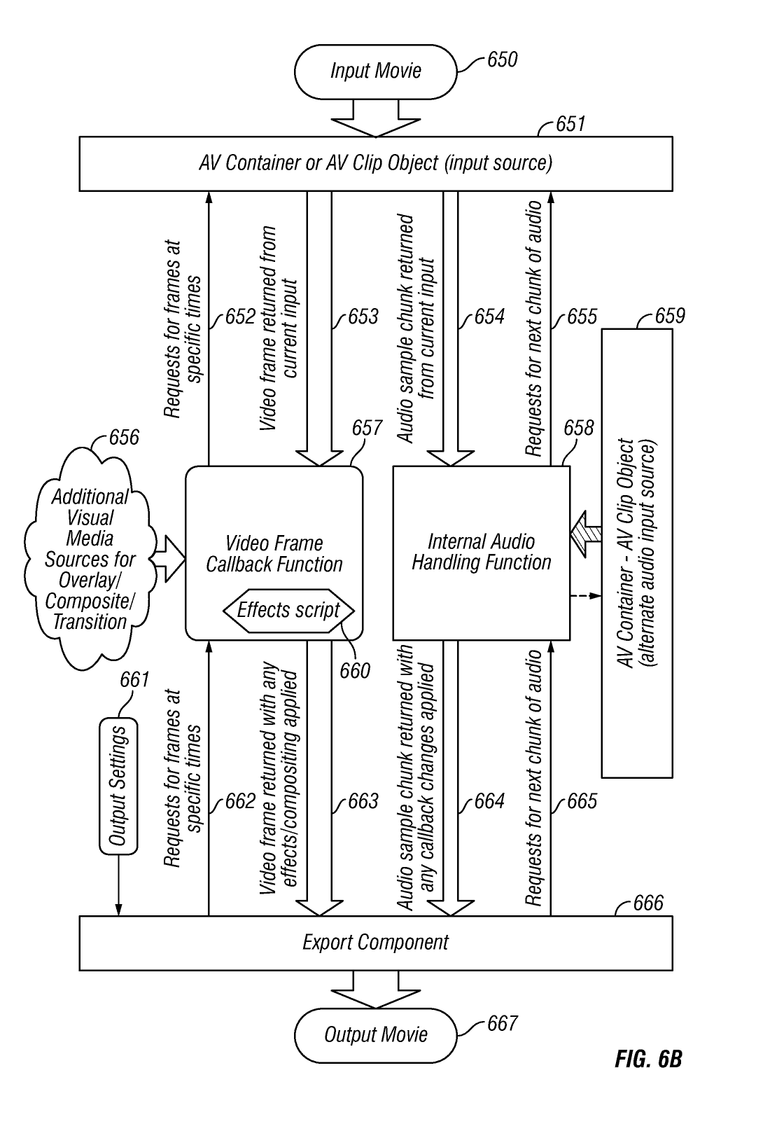

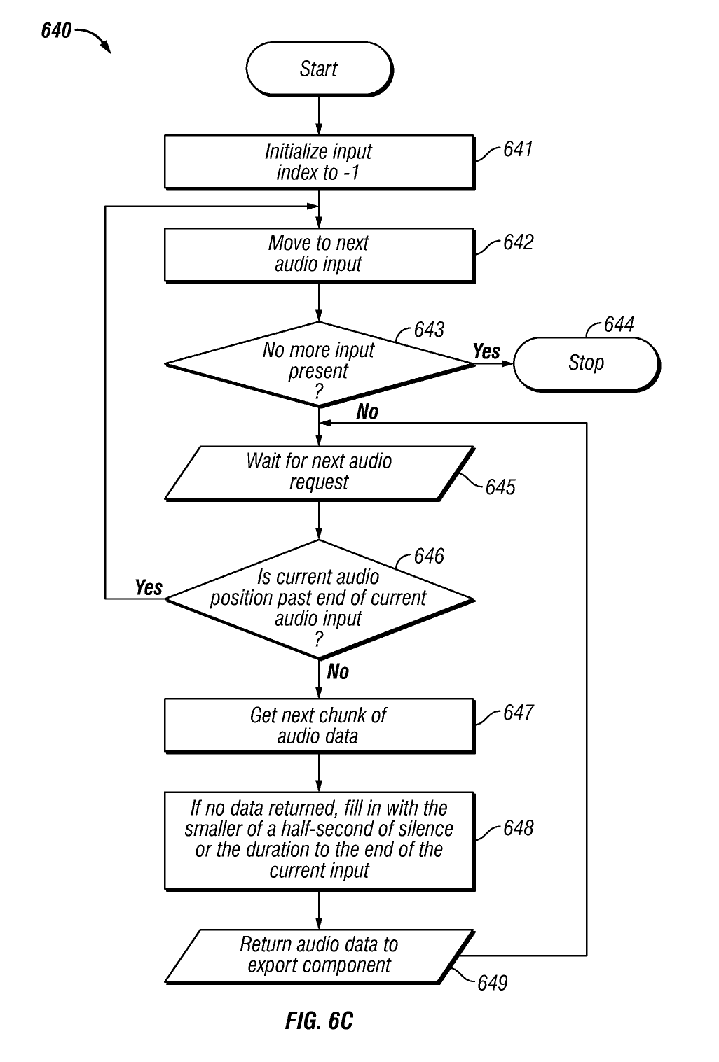

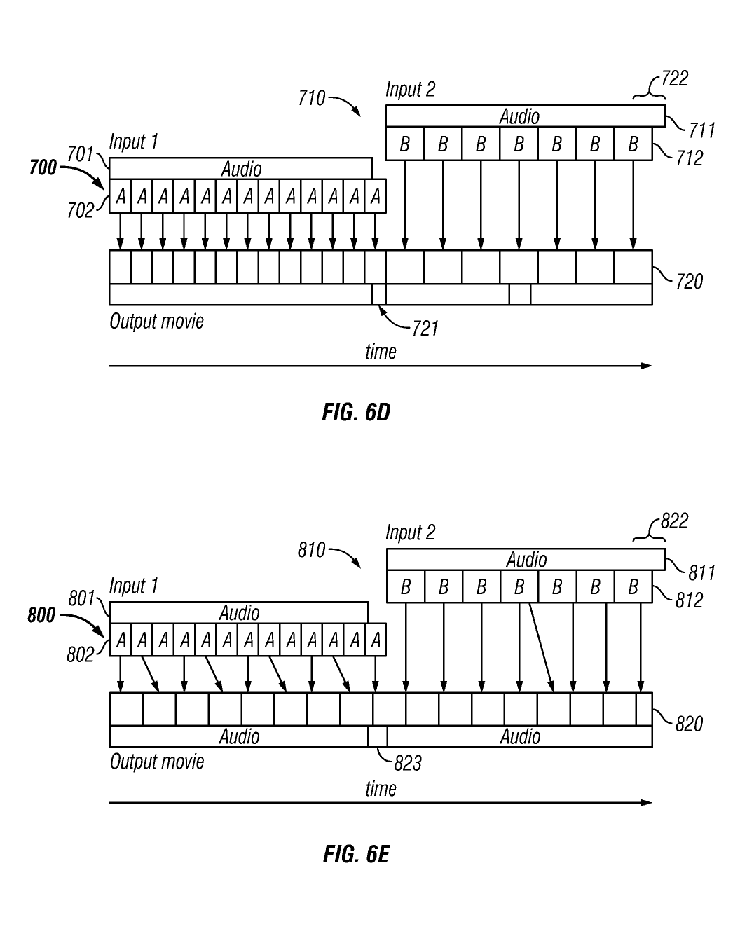

One embodiment comprises a hosted, cloud-based service that automatically transforms video on-the-fly, virtually eliminating the labor intensive preprocessing of video content and the programming exercise normally associated with supporting multiple devices. Thus, virtually any video file of any size from any application, Web page, or phone can be uploaded automatically. No pre-processing is required. Embodiments of the invention automatically direct users to the right asset for their bandwidth and device, while also providing the ability to upgrade their quality level to the next available, should enhanced resolution be required. This aspect of the invention is discussed in greater detail below in connection with FIGS. 5 and 6.

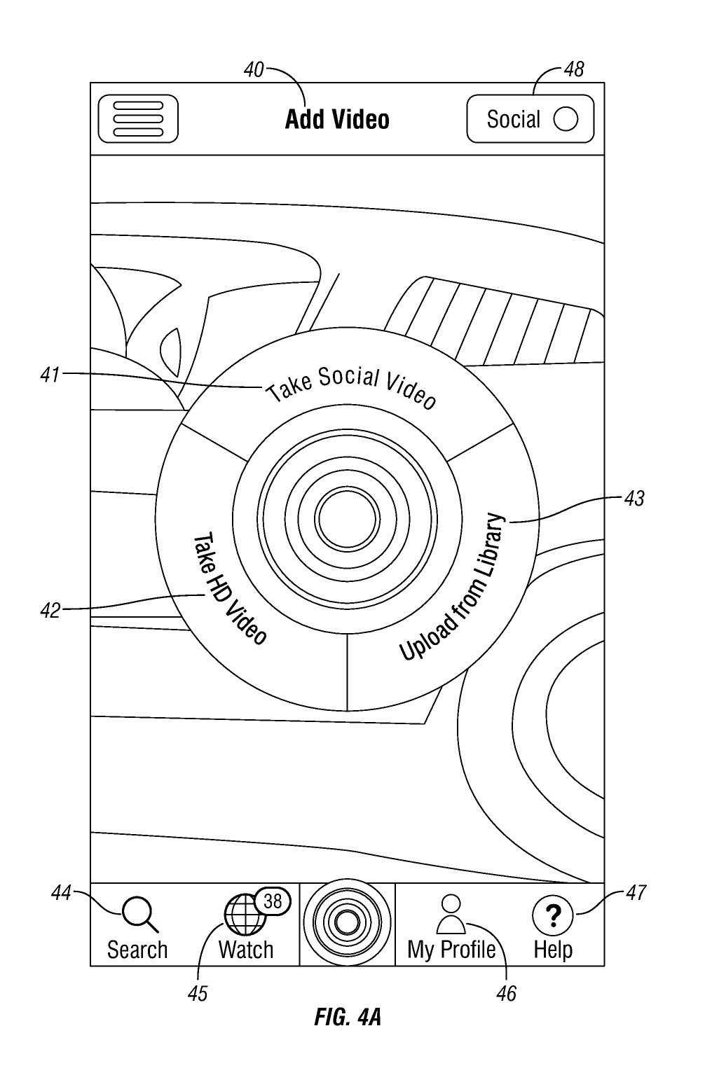

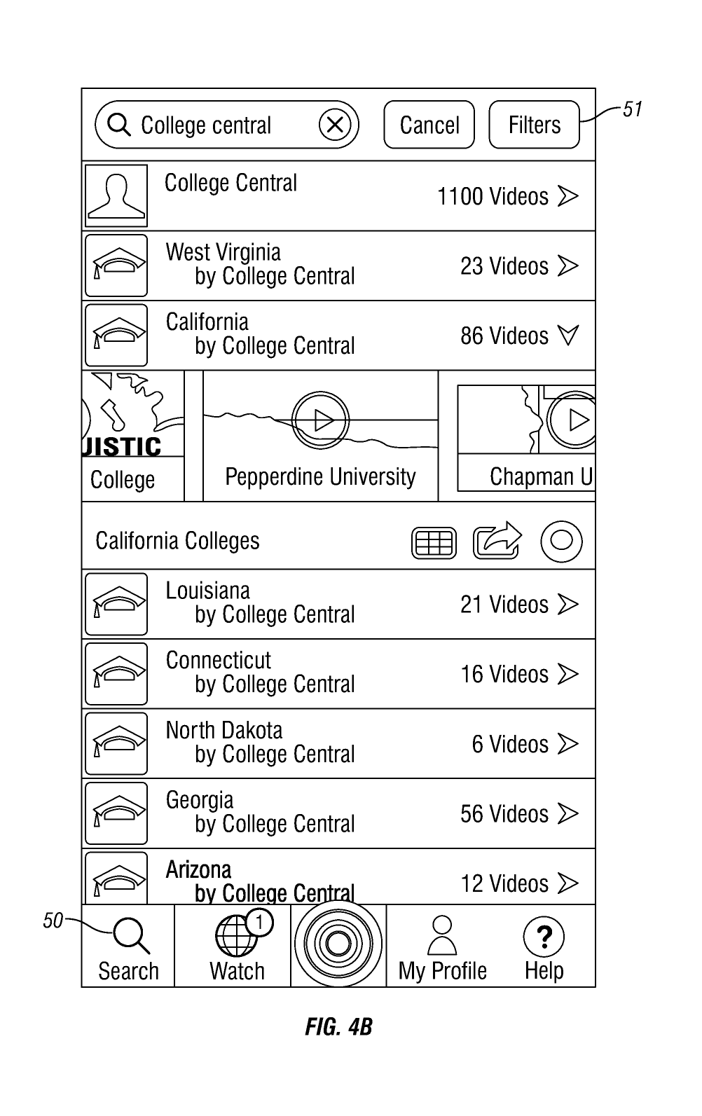

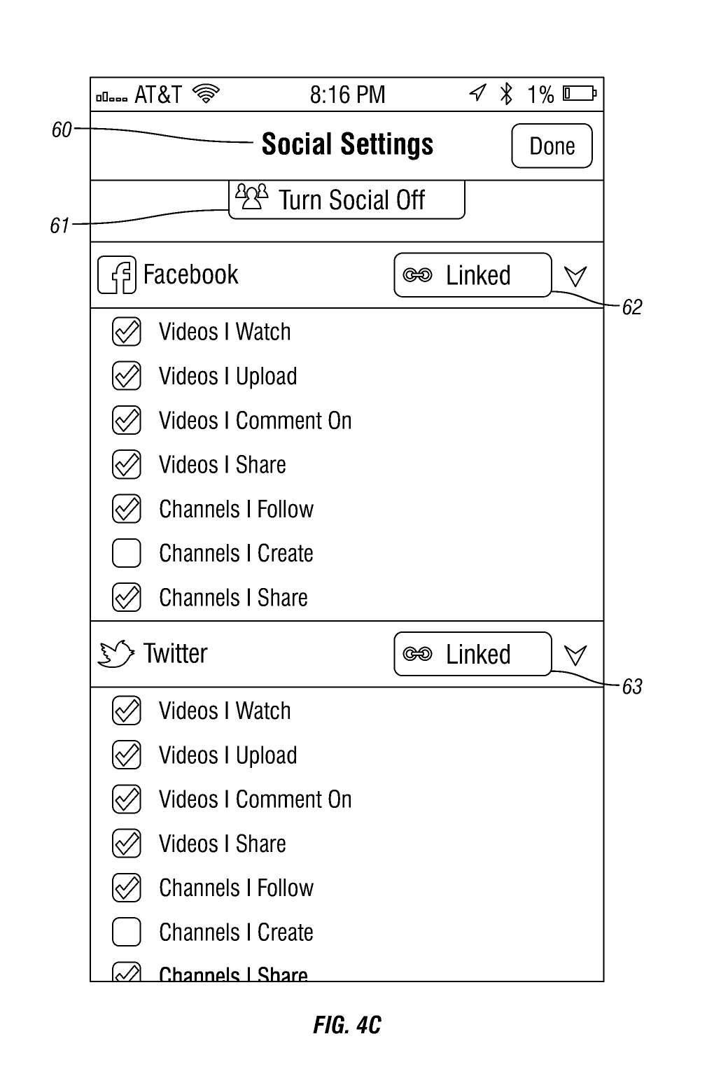

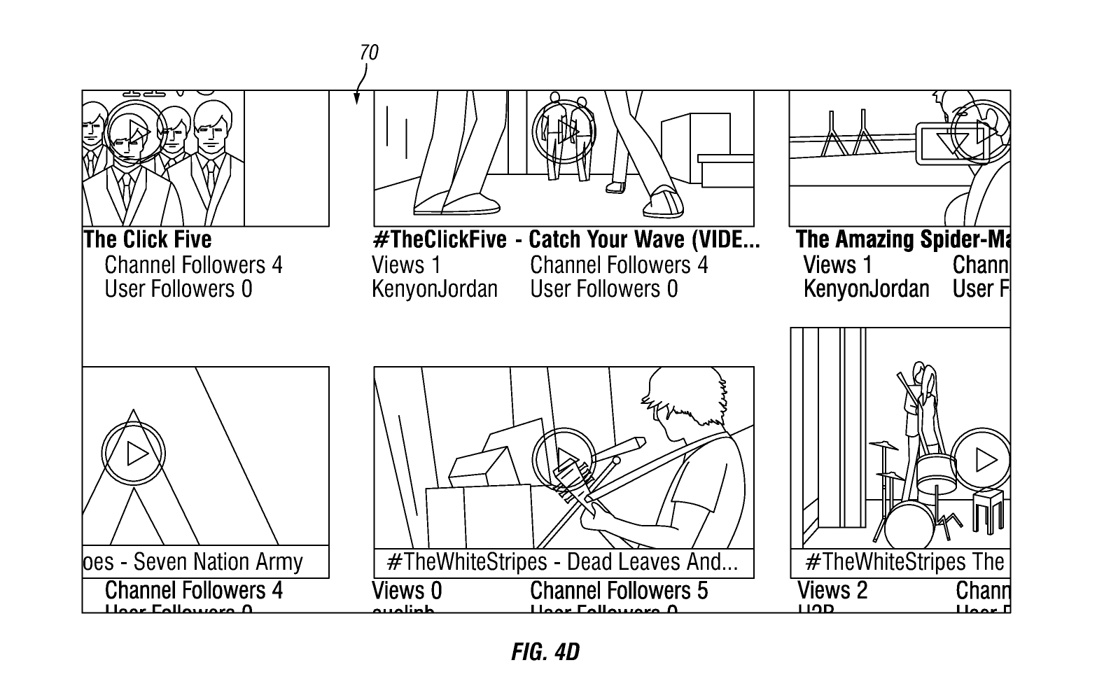

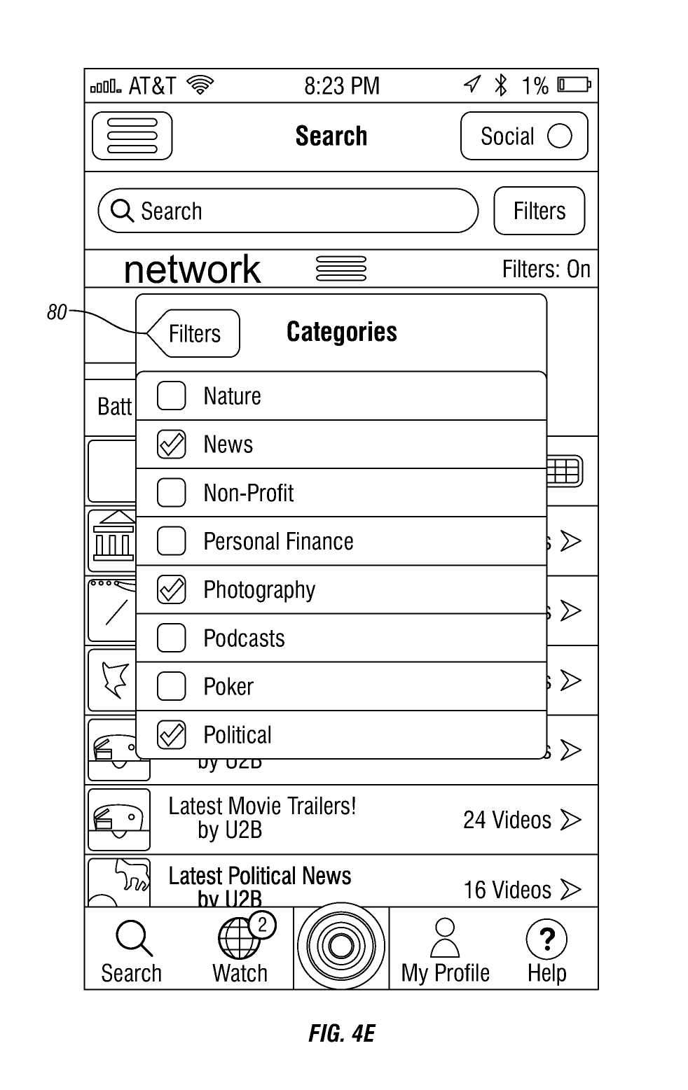

FIGS. 4A-4E are screen shots of an application running on a handheld device that implements a social video network according to the invention. An embodiment of the invention provides a social video network over which users can upload high quality (HD), e.g. 1080p, videos directly from their camera, via an API connected to other cameras or applications, from a Website, Facebook, or from their photo library into customizable video channels and automatically publish them to all who subscribe. Full friend following and invitation capability allows users to follow all of a corporation, group, individual, or brand's complete channel list with a single click. Automation features enable direct-to-website publishing or direct publishing to a social network application, such as the Facebook App. Users can also share their videos instantly to, for example, Facebook, Twitter, email, and SMS and set up the application to do this automatically to make it easy.

Users can search, subscribe, invite others to follow their public video channels or to contribute to their channels. Users can manage their entire list of video channels everywhere, modify their associated metadata content and make channels public and private, all on-the-go or wherever they log in. Users can upload videos of any size or type to their account from the Web or from within the application.

Users can also upload and manage channels, create and send private invitations, upload files of any type and size at the social video network website, e.g. http://eqnetwork.com. In such case, all subscribers of a channel are notified of the new video and can play the new video whenever they want. Users can edit their invite list of viewers per channel at any time. Users can also record “like a DVR” by subscribing to complete channels which automatically synchronize into all of their devices.

Users can increase the resolution of their video feed if higher quality is available and display the feed on, for example, Apple Airplay or with a converter cable to any screen. Effectively, this embodiment provides a DVR in the user's pocket from all of the video sources that the user subscribes to or creates. Thus, this embodiment of the invention provides a pocket-sized DVR for every video source. As such, a user can watch videos wherever they are, whenever they want. Alerts show the user what is new and what is popular. All of the user's videos are in one place on any device, with complete control of all channels.

FIG. 4A shows an Add Video screen 40 for a social video network application, in this example for an Apple iPhone. User controls include a search button 44 which allows a user to search through videos, a watch button 45 which allows a user to watch videos and with which a notification is provided regarding unwatched or new videos (in this case 38 videos are available, as shown), a profile button 46 with which the user can set personal preferences and save personal information, modify their individual channels and content metadata, make video channels private or public, invite people to follow user, invite users to follow private and public channels, and a Help button 47 with which a user can get assistance in using the application.

FIG. 4A also provides control buttons with which the user can take a social video 41, take an HD video 42, and upload a video from a library 43. As can be seen in FIG. 4A, the video is added to a social network 48, as selected by the user. In this example, the upload from library function is highlighted, which indicates that the user is uploading a video to the social network from the video library.

In FIG. 4B, the Search function 50 is highlighted. Here, the user has searched for College Central, and also applied a filter 51 which displays California Colleges. For each search results returned, a number of available videos is shown, e.g. 21 videos are shown for colleges in Louisiana.

In FIG. 4C, the user's social settings 60 are shown. In this example, the social setting are turned on, but the user may turn them off by selecting a button 61 if desired. As shown, the user has linked to Facebook 62 and Twitter 63. The user may select among various properties for each of these linked social services, including for example Videos I Watch, Videos I Upload, Videos I Comment On, Videos I Share, Channels I Follow, Channels I Create, and Channels I Share. In FIG. 4C, user selection are indicated by a check in a checkbox.

In FIG. 4D, the user's videos 70 are shown as simple animations of the content that the user has sent. Metadata associated with the videos is also indicated which, in this example, includes Channel Followers, User Followers, Views, and viewers names, e.g. KenyonJordan.

In FIG. 4E, the user filters 80 are shown for the Categories filter. Those skilled in the art will appreciate that any number of filters can be applied and that filter are not limited to Categories. With regard to the Categories filter, the user selects those categories of interest, as shown by the check in the checkbox, e.g. for News, Photography, and Political.

On-Demand Media Processing Engine

Central to the social video network described above is an on-demand media processing engine that automates the production of images, animations, audio, and video. In some embodiments, the media processing engine is integrated into the system architecture. In some other embodiments, the media processing engine comprises a standalone peripheral device.

The media processing engine enables end-to-end ingestion and delivery of media assets to and from any device/platform. Examples of typical destinations include IP television, broadcast television, video on-demand, Web streaming, computer downloads, media players, cellular devices, personal digital assistants, smart-phones, and Web pages. The engine also allows a user to auto-assemble programs on-the-fly as they are deployed, for example by adding other content, such as advertisements.

As explained above, the content provider is a user who posts video, for example to a social Website. The content consumer then finds or is invited to a channel that presents the video and requests that the video be sent to a video-enabled cellular phone to view the video. In an embodiment of the invention, the content consumer may enter personal demographic information along with this request, or such information may be required to access the content provider's channel.

The content provider posts the video in a native format for the video. Accordingly, in one embodiment, a request made by a content consumer begins a process of on-demand media processing. FIG. 5A illustrates a schematic representation of an exemplary process 500 defined by a request for content according to some embodiments of the invention. The process 500 begins with a content consumer requesting content 501, either directly or via a channel subscription, e.g. where the content is automatically delivered to the content consumer via a predetermined subscription. In some embodiments, the request is accompanied by demographic or other channel-specific information. In some embodiments, the channel-specific information is supplied explicitly through a subscription widget in an application. In some other embodiments, the channel-specific information is supplied from a secondary source. For example, the information may be stored by the content provider or supplied by a third party. In some other embodiments of the invention, the channel-specific information is predicted contextually. For example, when a request for content is made from a Website that only delivers children's entertainment content, it is likely that the audience viewing the content is comprised primarily of children. In such case, one or more appropriate channels are suggested for subscription.

The process 500 continues by determining the requested output device's settings 502. For example, if a digital video is requested, the process 500 determines, for example, the video output device's video playback speed requirements, screen size, and resolutions limits. Based on the determined settings, the process then defines output requirements for the media asset or selects from a set of pre-prepared assets in case no unique asset requirement is determined or auto-assembly is required to create a personalized asset 503.

FIG. 5B illustrates a representation of an example of a new media definition 599 according to those embodiments of the invention that include other content, such as advertising with the requested or subscribed content. In this example, the media definition 599 identifies the content 596 prefaced by a pre-roll advertisement slot 598 and a first advertisement slot 597. Similarly, the content 596 is followed by a second advertisement slot 595, a third advertisement slot 594, and a post roll slot 593.

In some embodiments of the invention, the content 596 is segmented for additional content insertion. For example, content 596 having a long run time may be segmented every few minutes for the purpose of serving an advertisement or providing other content. According to these embodiments, scene detection algorithms and audio pause detection mechanisms are employed to detect appropriate times to segment the long-form media. One scene detection method looks for frames that have a large difference from the previous frame, but not including frames defined with a lot of action. This discriminator is achieved by converting each frame to gray scale, performing an edge detect on these frames, normalizing the edge detect image so it always has some number of fully black and white pixels, and then differencing this detect with the previous frame's edge detect. If the difference between edge detected frames is high and the amount of white vs. black is low on the current edge detected frame, and other requirements such as minimum and maximum amount of brightness of the original frame are met, the frame is marked as a scene change. Audio silence detection for scene change is accomplished by marking the start of where audio volume is below a set threshold, and if that threshold is maintained for a set amount of time, the segment can be marked as a scene change if the video aspects also allow it as a scene change.

Referring again to FIG. 5A, after defining the new media 503, the process 500 continues with identifying additional content, such as advertisements for a new composite media definition. In some embodiments of the invention, the advertisements are identified by cross referencing gathered demographic information with the advertisement provider's advertisement campaigns. Typically, the identified advertisements and the content media are not perfectly homogeneous. For example, the advertisements and the content likely have different file types, frame rates, resolutions, audio types, etc. FIG. 5C illustrates an example of a composite media definition 599 after advertisements have been selected for the ad slots 593, 594, 595, 597, and 598, wherein the advertisements comprise diverse audio/video file formats.

Referring again to FIG. 5A, once the video assets are identified, the process 500 digitally funnels 505 the content and other content, if applicable, such as advertisements, on-the-fly to create the new media asset. The process of digital funneling is explained more fully below when discussing FIGS. 6A through 6E. The process of digital funneling 505 results in a new media asset in the user defined format with the appropriate settings for playback on the chosen output device.

The process 500 continues after digital funneling 505 by delivering the new media. In some embodiments, the process 500 automatically delivers the media 506A to the requesting content consumer. In some other embodiments, the composite media is stored 506B before delivery. According to these embodiments, a subscribing content consumer can be sent an email 507B with a hyperlink, linking the user to the stored media, although the presently preferred embodiment of the invention simply pushes the content to the subscriber's account and, in some embodiments, posts a notification that new content is available. In some embodiments, the content may be stored on the subscriber's device and viewing without regard to an Internet or other network connection. In some embodiments of the invention, a hyperlink may be accessed for viewing the media from anywhere including a network-based browser, portable devices, digital video recorders, and other content portals, now known or later developed.

FIG. 5D illustrates an alternative representation of an alternative method 600 for delivering digital media according to some embodiments of the invention. The method 600 begins as a user makes a subscription request 601 asking that a video be prepared and delivered. During the request 601 process, a set of demographics concerning the target user is collected. Next, the system determines 602 if an appropriate version of the video has already been generated that contains, for example, ads targeted to that set of demographics based on the source video and the user's demographics, or based upon subscriber information and/or subscriber filters/profiles. Next, if an appropriate video has already been generated, then the system skips 603 the generation process and proceeds directly to the sending phase (step 608). On the other hand, if no appropriate video yet exists, then the request is sent 604 to a delivery processor to cause an appropriate video to be generated.

Next, the delivery processor generates a request 605. This request includes all available information about the user that requested this video, including the kind of device that is targeted, any demographics collected for that user, and the target address list. This request is submitted, for example, to a social video server, which responds 606 by sending back, for example, content targeted to the requesting user. The response may not itself contain the content, but may rather contain references to content to allow the content to be requested via additional requests. The delivery processor then produces 608 a derivative video containing the primary content that the user requested, as well as any ads or sponsorship that target that user. In addition, other branding, pre/post roll video content can be added to dynamically generated localized content based on the current geo location, user demographic, or other variables. It places this derivative video in a video cache 607.

Next, the delivery processor 609 posts the availability to EQ Network, and simultaneously posts the availability to other social networks via a notification server. All that have subscribed to the channel the video is in are delivered either a notification, or the file is synchronized into the client.

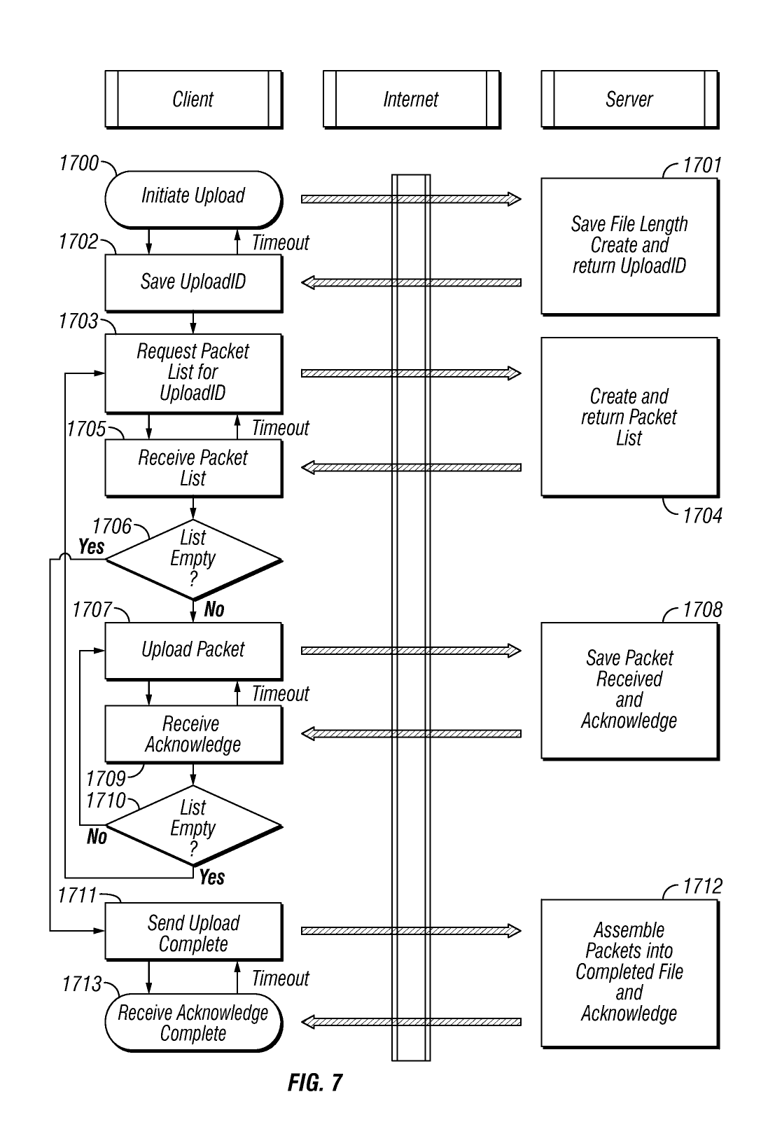

A key aspect of the invention is the ability that it provides to upload HD videos from devices on any speed network in a start, stop, start mode. An embodiment of the uploader operates as follows (see FIG. 7):

The Client tells the Server the size of the file that is going to be uploaded in 1700. The Server responds with an UploadID in 1701. The Client saves the Upload ID in 1702. From this point on, the server takes control of tracking what has been uploaded and what is still needed.

Then we perform the major data upload loop:

1) The Client asks the server “Give me a list of N packets to upload for this UploadID?” in 1703.

2) The Server responds with a list of information on N packets in 170 for each packet it has the starting offset and the length of the packet.

3) The Client receives the packet list from the server in 1705; if it times out, go back to step 2.

5) If there are no more packets then we are done in 1706.

6) The Client uploads each packet as specified in 1707. If a packet has an upload error it is ignored.

7) The Server saves a successfully received packet and acknowledges the receipt of a packet in 1708.

8) The Client receives an acknowledgment that the packet was received by the server in 1709. If it times out, go back to step 6).

9) When all N packets have been attempted in 1710, go to step 1).

The key here is that packets that did not make it are re-listed, as shown in Step 2), because the server knows if a packet did not upload successfully (communication failure, timeout, or checksum mismatch). This is important (that the server is in control) because the Client may not even know that a packet upload succeeded (due to bad network communications).

This process can occur over and over in low-bandwidth situations until all packets are successfully uploaded.

When all packets have been received in 1711 the Client notifies the Server that it is aware that all packets have been uploaded. Then the Server in 1712 finishes assembling the packets into a completed file in 1712. Then the Client receives an acknowledgment that this has finished in 1713. And then the process is finished.

Notes

One important factor for receiving a list of packets to upload is that several packets can be uploaded at once. This can improve upload performance in that in each packet upload there is a back and forth communication that occurs in the underlying protocol, e.g. http, and uploading several at once fill in the holes created by this back and forth communication.

A further improvement is that as packets are uploaded successfully, the preferred packet size can be increased and, as failures occur, the preferred packet size can be decreased. A smaller packet size introduces more overhead but, generally, has better odds of succeeding.

Sometimes a packet comes in twice (or overlaps with another because of changing packet sizes and errors). In this case, the first one successfully received invalidates subsequent packets received that overlap this one and these subsequent packets are ignored. In the meantime, the next response from the server includes any remaining gaps for which data is needed.

In a very messy communications environment these gaps can end up being very odd sizes, but nevertheless because they are tracked on the server they are eventually filled in with successful packet uploads.

When making the request in step 1) the current preferred packet size is also transmitted. Generally, the length of a packet (in the list returned) is the preferred size, but it can be smaller due to the fact that smaller sized gaps in the data need to be filled in.

In our case, individual packets are stored to disk and, when all packets have been received, they are assembled into the complete file in their proper order (file offset). This assembly could also begin once multiple packets exist with no gaps between and continue in this manner as additional packets are received without gaps, thus eliminating a long delay if the full file is reassembled only after all packets have been received.

The number of packets requested (N) is up to the Client and depends on the amount of memory available.

At any time an upload can be paused and then restarted by making a new request to the server for the list of packets to upload (for a given upload) and proceeding to continue uploading packets.

In addition, multiple files can be uploaded at once because of the use of an Upload ID. The server keeps track of what packets have been uploaded for each UploadID. Priorities can change and more (or only) packets for higher priority uploads can be uploaded. Once higher priority uploads have completed the lower priority uploads can continue. Again, the fact that multiple packets can be uploaded at the same time (even from different files) can overcome some of the inefficiencies of the underlying protocol.

Because each packet has a checksum, there is no need for an overall file checksum calculation which speeds the final re-assembly of packets into a whole file.

These techniques create an extremely reliable uploader that guarantees eventual complete and accurate upload of a file even with minimal bandwidth availability.

The variables that can be adjusted to tune this algorithm include N, the initial preferred size of a packet, when and by how much to increase the preferred size of a packet, when and by how much to decrease the preferred size of a packet, and the number of packets to send at a time. In our production environment we are using 10 for N and 4096 as the initial preferred packet size. After three successful packet uploads in a row we double the preferred packet size. After three unsuccessful packet uploads in a row we halve the preferred packet size. The minimum preferred packet size is 256 and the maximum preferred packet size is 262144. We also limit the number of packets sending at the same time to four. These values are adjusted and controlled on the Client side.

Digital Funneling

The process of digital funneling consists of obtaining a plurality of media files and automatically assembling the files. As explained above, the process ingests various media content and, in some embodiments, advertisements, each of which may be ingested as unique or diverse audio formats and video formats. A number of variables may differ between the formats including, for example, bit depth, audio rate, scaling, and bitrate, among others. Most significantly, the various video formats may each have different video frame rates, frame dimensions, color space, different codecs, differing container formats, and varying audio tracks.

The media processing engine converts the media files in various video formats to the new media file by converting the media files, from their native timescale units to a standardized timescale. In some embodiments of the invention, the standardized timescale is in seconds; however, a person with ordinary skill in the art will understand that any timescale can be used to achieve the novel aspects of the invention. Using this conversion, any video file can be synchronized to an internal clock. Accordingly, after the conversion, it does not matter what the native frame rate was, so long as the processing engine can tell what frame is being presented at a given time being kept by the internal clock. For example, 5.345 seconds (internal clock time) into a first movie file with a frame rate of 12 frames per second (FPS) is the equivalent of 5.345 seconds into a second movie file with a frame rate of 29.97 FPS. For either of these formats, the processing engine pulls whatever frame corresponds with a chosen internal clock timestamp. All total durations, frame durations, and seek positions are converted from the output movie file's timescale to seconds and then to the current input movie's timescale and (for seeks) to its local time.

In some embodiments, the native media format requires a preprocessing step to normalize the scale of the media file. According to these embodiments, the media processing engine recognizes that the ingested file format does not fit the output media dimensions. Accordingly, the engine scales the image on-the-fly to match that of the output movie and/or other inputs.

In some embodiments, the engine converts the file into an intermediate movie file of the appropriate dimensions before making the conversion from native timescale to an internal clock time. Intermediate movies are typically only required to work around known export issues with certain QuickTime formats, e.g., iPhone, iPod, Apple TV, 3g, among others. Intermediate movies are not needed for any formats with AVCore 2. The output movie is run through a hinting tool to ensure maximum compatibility.

FIG. 6A illustrates a schematic representation of an on-the-fly video export process used in digital funneling according to some embodiments of the invention. The process 620 begins with initializing 621 an input number index.

The process then moves to the next input 622 and determines 623 whether any more inputs are present. If so, the engine calculates 624 the duration of the input media file based on the desired output time scale. The engine then creates a ratio 625 of the media file input time to the output time scale.

The process 620 continues by determining 626 whether the current input is the last input. If so, the engine applies a correction factor 627 and proceeds. If not, the process 620 continues frame requests.

The media processing engine waits 628 for frame requests and, when a frame is passed, determines 629 whether the input source has been synchronized from its native timescale. If synchronization is required, the engine subtracts the end time of the previous input from the requested time and then subtracts that from duration of the current inputs 630. The engine then determines 631 whether the newly requested time is prior to the previously requested input time. If so, the process reverts to initialing the input 621 and proceeds accordingly. If not, the media processing engine determines 632 if the input source request time is past the current input duration, and if so, reverts to moving to a next input source 622. If the input source is properly positioned (as determined in steps 631 and 632), the media processing engine converts 633 the requested time to an internally synchronized time (in seconds) using the ratios calculated in step 625. Next, the media processing engine call processes the object's frame call back function 634 to return a frame. In some embodiments, the processing engine performs other frame processing at this point (scaling resolution, padding edges, etc.) Next, the processing engine processes 635 an object's effects (fade in/out, panning, zooming, etc.), if any.

Finally, the process 620 converts 635 a returned frame duration from the internal time clock time (in seconds) to the output timescale and determines 636 if a frame is returned. If a frame is returned, it is sent 638 to the export component and used in the composite media file. If an actual frame is not returned, the media processing engine uses 637 the last valid frame as the returned frame and exports 638 that frame to the export component. The process 620 reiterates with pulling new frames until the composite media file is built as defined by the request for media.

In some embodiments of the invention, particular processing steps are known in advance for known output formats. In particular, it is desirable to know certain required steps for initializing certain file types for exporting the media. For example, when the media processing engine receives instructions to process a QuickTime Movie, it can reference a set of known rules relating to various processing steps required for processing. No rules are needed for AVCore 2. Ffmpeg handles the details internally.

Following the previous example, when the media processing engine encounters a QuickTime Movie, it can reference the set of rules contained in Table 1 to determine that processing requires that the engine use integer audio samples and that an intermediate movie be processed and flattened for final export.

Digital funneling various input media files into a new media file also involves synchronizing the audio signals associated with the various input files. For example, a new composite media definition may include input files with different audio file types. The media processing engine handles this situation by determining the audio sampling rate for all of the various inputs, determining the highest common denominator and converting all the inputs to the highest sampling rate. However, with AVCore 2 the input audio rates are all normalized to the output setting's output rate.

FIG. 6B illustrates an example of digital audio/video funneling according to some embodiments of the invention. As explained above, the invention ingests a plurality of input movie files 650, 656 and exports an output movie 667. In this example, the input movie 650 comprises a QuickTime Movie 651. The processing engine contains a video processing node 657 and an audio processing node 658. The video processing node 657 includes a video frame call back function (described above) and an effects 660 adding function.

Additionally, an export component 666 contains a definition of the requested new composite media, defined by a user. The output settings 661 are preferably saved.

The export component 666 is timed on an internal clock and makes a request 662 for the frames of a given input at specific time. The video processing node 657 makes a request 652 to the QuickTime Movie input for the frames that synchronize with specific times on the internal clock. In response to these requests, the input provides video frames 653. The video processing node 657 adds any effects to the frames that are applicable, and then returns 663 the video frames to the export component 666. The process of sending frame requests and returning frames from an input file based on an internal clock is reiterated, as described in FIG. 6A.

Additionally, the audio processing node 658 contemporaneously receives requests from the export component 666 for the audio chunk that corresponds in time with the current frames. The audio processing node 658 requests audio input 655, ingests audio inputs 654, and returns the appropriate audio output 664 to the export component.

FIG. 6C illustrates a schematic representation of an on-the-fly audio synchronization process 640 used together with the video processing for digital funneling according to some embodiments of the invention. The process 640 begins with initializing a file input index parameter 641. After initialization, the process 640 moves 642 to a first (or the next) audio input. If the engine determines 643 that there are no more audio inputs present, the process 640 ends 644.

Alternatively, if more audio inputs are found, then the process 640 waits 645 for the next audio input and, when received, determines 646 whether it is in the appropriate position. If not, the process returns to step 643 and move to another audio file. If the audio request is in the appropriate position, the process 640 locates 647 a chunk of the audio signal to be output as the exported audio signal 649. If audio is present for a given time position, the process 640 fills in the output with the smaller of a half-second of silence, or the duration to the end of the current input. The process 640 concludes with sending output audio data to an export component 649.

FIGS. 6D and 6E illustrate examples of assembling a user-defined composite media file from a plurality of input files. In FIGS. 6D and 6E, frame rate is represented by the width of frames A and B, in relation to the horizontal time axis.

FIG. 6D illustrates a first example including a first input 700 and a second input 710. The first input 700 includes an audio component 701 and a video component 702. The video component 702 includes frames A. Likewise, the second input 710 includes an audio component 711 and a video component 712. The video component 712 for the second input includes frames B.

According to this example, the user-defined output movie setting does not include a specified frame rate. Therefore, the media processing engine can simply concatenate the two inputs without having to worry about sampling up or down to a specific frame rate. The output movie 720 simply uses the frames A and frames B in sequential order, as indicated by the arrows. This is not applicable in all cases in embodiments with AVCore 2. While ffmpeg always requires a fixed output frame rate, other plugins for AVCore 2 may not impose this limitation.

A potential complication exists when the audio component 701 of the first input does not exactly match the duration of the video component 702 first input, or when the video component 712 of the second input does not match the duration of the audio component 711 of the second input, as shown in FIG. 6D.

According to some embodiments of the invention, interior audio track splices 721, for example, have silence inserted to match the longer video track. Likewise, interior video track splices (not shown) may be compensated for by increasing the duration of the last frame to match a longer audio track. Similarly, exterior audio or video tracks 722 may be truncated or extended to accommodate longer audio/video counterparts.

FIG. 6E illustrates an example of a user-defined output movie with a specific frame rate including a first input 800 and a second input 810. The first input 800 includes an audio component 801 and a video component 802. The video component 802 includes frames A at a first frame rate. Likewise, the second input 810 includes an audio component 811 and a video component 812. The video component 812 for the second input includes frames B, at a second frame rate.

Because the output movie's 820 frame rate is lower than that of the first input 800, certain frames (those without an arrow) are dropped from the resulting output movie 820. The media processing engine applies an algorithm that takes the requested start time of the output and looks at which frame that requested time falls in between the input movie's corresponding start time and end time. According to FIG. 6E, the requested output times correspond with the left edge of each frame box, and the end time of each frame is by each box's right edge.

Similarly, because the output movie's 820 frame rate is higher than the second input's 820 frame rate, certain frames are duplicated, as indicated by frames having multiple arrows. The frame to duplicate is based on where the requested output frame's start time falls between the corresponding input movie frame's start time and its end time.

Because the output movie 820 specifies a frame rate, the last frame in each input will take on the duration of the output frame rate. The frame is not truncated to the end of the input movie, and the audio is not extended. However, the audio is still extended with silence 823 so it at least matches the length of the first input 800 video component 802. The silence 823 is not noticeable since the start of the next audio input (audio component 811) overlays the previous input by a mere fraction of a second. Similarly, exterior audio/or video tracks 822 may be truncated or extended to accommodate longer audio/video counterparts.

Computer Implementation

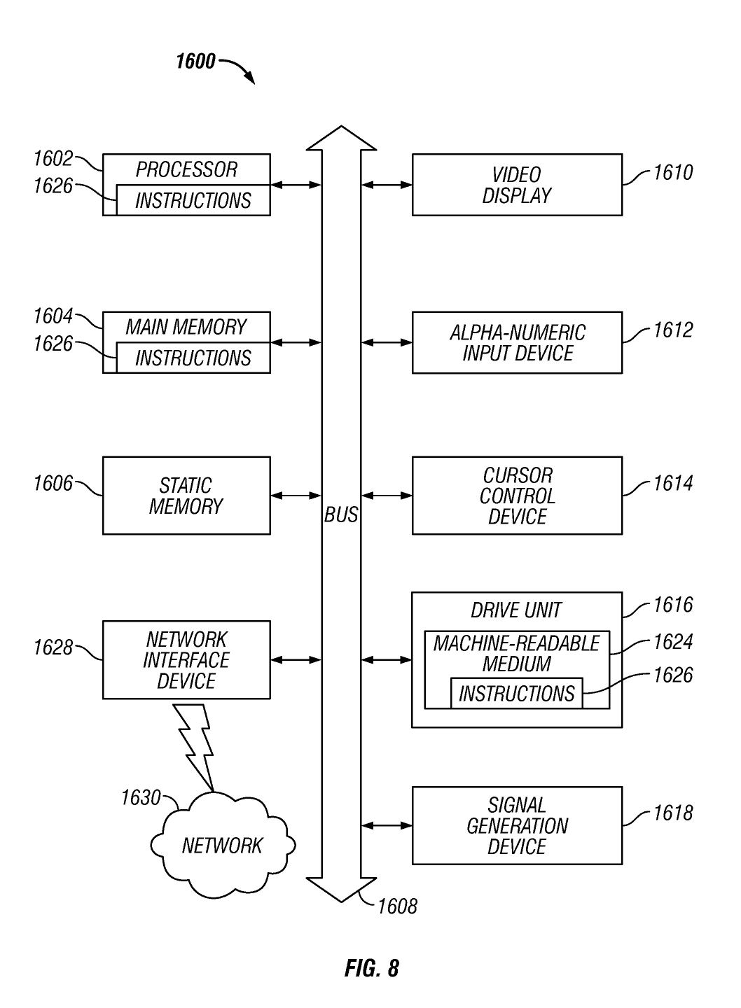

FIG. 8 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for ingesting, distributing, and maintaining video assets, comprising:
a social media processor in communication with a social media application, said social media processor ingesting, distributing, and maintaining video assets in response to instructions from a user of said social media application, said user instructions establishing said distribution channels; and
an on-demand media processor in communication with said social media processor for performing end-to-end ingestion and delivery of said video assets via said distribution channels to and from a plurality of disparate subscriber devices and platforms by converting said video files to any of a plurality of disparate destination video formats from a video source having a native format in real time.

2. The apparatus of claim 1, wherein said channel comprises any of one or more public and private channels that are automatically pushed to all subscribers thereto.

3. The apparatus of claim 1, wherein said subscriber devices comprise any of mobile phones, tablets, computers, and Internet TVs.

4. The apparatus of claim 1, wherein said video source comprises any of a file and a camera.

5. The apparatus of claim 1, said social media processor automatically logging user video assets as animations showing content that the user has sent and automatically updating all subscribers of a user's channel instantly when the video asset is ready to view.

6. The apparatus of claim 1, said social media processor automatically synchronizing what a user has watched.

7. The apparatus of claim 1, said social media processor providing a personal video network with which a user selects among functions that include any of crowd source, location enabled, and invitation only communication.

8. The apparatus of claim 1, said social media processor sending videos from the field to a viewer, allowing users to follow news communities, and permitting viewer enabled contributions.

9. The apparatus of claim 1, wherein said channels are privacy protected as desired or designated.

10. The apparatus of claim 1, wherein, via communications between said social media application and said social media processor and in response to said communications by said social media processor, a user of said social media application uploads a video asset directly from a user device, shares and stores said video asset over a social network via one or more of said channels, and watches said video assets at any locations and on any device as desired.

11. The apparatus of claim 1, wherein, via interaction of said social media application with said social media processor, said user creates and publishes private or public video channels that are automatically pushed to all who subscribe to such channels.

12. The apparatus of claim 11, wherein said private video channels never show up in search or public video channels but are available for anyone to subscribe to and follow.

13. The apparatus of claim 1, wherein every subscriber receives a video asset the instant a user uploads it, without the user sending e-mails or the subscriber being required to visit a Web site.

14. The apparatus of claim 1, said social media processor providing favorites to enable automatic push of channel video assets that allow a user watch said video assets without an Internet connection.

15. The apparatus of claim 1, said social media processor comprising a hosted, cloud-based service that, in conjunction with said on-demand media processor, automatically transforms said video assets on-the-fly.

16. The apparatus of claim 1, said social media processor providing said user, via said social media application, with customizable channels for automatic publication of said channels to all who subscribe thereto, full friend following and invitation capability to allow users to follow any of a corporation, group, individual, or brand's complete channel list, direct-to-website publishing or direct publishing to a social network application, and instant sharing of video assets instantly to social media;
wherein, via said social media application in conjunction with said social media processor, said user can search, subscribe, invite others to follow their public video channels or to contribute to their channels, manage their entire list of video channels everywhere, modify their associated metadata content, and make channels public and private, all on-the-go or wherever they log in, and upload videos of any size or type to their account from the Web or from within said social media application.

17. The apparatus of claim 1, wherein, via said social media application in conjunction with said social media processor, users can upload and manage channels, create and send private invitations, and upload files of any type and size at a social video network website;
wherein all subscribers of a channel are notified of a new video and can play said new video whenever they want.

18. The apparatus of claim 1, wherein, via said social media application in conjunction with said social media processor, users can subscribe to complete channels which automatically synchronize into all of their devices.

19. The apparatus of claim 1, wherein, via said social media application in conjunction with said social media processor, users can increase resolution of their video feed if higher quality is available and display the feed;
wherein a user can watch video assets wherever they are, whenever they want, in whatever format is available on a current display device.

20. The apparatus of claim 1, wherein said social media processor provides alerts to show a user what is new and what is popular.

21. The apparatus of claim 1, wherein, via said social media application in conjunction with said social media processor, users can set profile attributes and define search functions.

22. A computer implemented method for ingesting, distributing, and maintaining video assets, comprising:
providing a social media processor in communication with a social media application, said social media processor ingesting, distributing, and maintaining video assets in response to instructions from a user of said social media application, said user instructions establishing said distribution channels; and
providing an on-demand media processor in communication with said social media processor for performing end-to-end ingestion and delivery of said video assets via said distribution channels to and from a plurality of disparate subscriber devices and platforms by converting said video files to any of a plurality of disparate destination video formats from a video source having a native format in real time.
